(19) United States
(12) Patent Application Publication
(10) Pub. No.: US 2016/0168379 A1
(43) Pub. Date: Jun. 16, 2016

(54) Binder Composition for Sublimation Printing Natural Fibers

(71) Applicant: Kwan Byung Lee, Pasadena, CA (US)

(72) Inventor: Kwan Byung Lee, Pasadena, CA (US)

(21) Appl. No.: 14/568,322

(22) Filed: Dec. 12, 2014

(51) Int. Cl. C08L 75/04; C08L 33/00; D06M 15/263; D06M 15/572; D06M 13/432; D06M 13/148; D06N 7/00; D06M 15/564

(52) U.S. Cl. CPC C08L 75/04; D06N 7/00; C08L 33/00; D06M 15/564; D06M 15/572; D06M 13/432; D06M 13/148; D06M 15/263; D06N 2203/068; D06N 2203/041; D06N 2211/12; D06N 2209/083

(57) ABSTRACT

A binder composition for sublimation-printing natural fibers of the present invention includes: (A) an aqueous solvent; (B) a moisture evaporation retardant selected from urea, glycerine, and a mixture thereof; (C) a (meth)acrylic polymer; (D) a polyurethane; (E) a blocked polyisocyanate; and (F) a paraffin wax.

### BACKGROUND OF THE INVENTION

(a) Field of the Invention

The present invention relates to a binder composition for sublimation printing of natural fibers, and more particularly, a binder composition capable of providing sublimation-printed natural fiber fabrics having improved color, sense of touch, color fastness, and wash fastness.

(b) Description of the Related Art

In general, dyeing indicates coloring an object (a thread, a fabric material, or leather) such as a fiber with a coloring material such as a dye, a pigment, or the like, and is classified into dip dyeing performed by dipping an object to be colored in a dye solution and dyeing it with one uniform color, and printing performed by patterning a part or most of an object to be colored with several colors.

This printing may easily form very complex and various patterns on a fiber cloth compared with the dyeing, and thus has been industrially widely used for a long time. The printing is appropriate for multi-kind and small-quantity production, since various colors and designs may be obtained by combining a plate and an ink. In addition, inkjet printing has been recently more widely used than conventional screen printing or roller printing, and as it needs no plate and is easier, use thereof is expanding.

At present, a commercially available ink for the printing is classified into a dye ink and a pigment ink, and the dye ink is classified into an acidic ink, a reactive ink, a dispersion ink, and the like. The pigment ink is somewhat commercially available but as it has a low color saturation degree or chromophore property, the dye ink is mainly used. The acidic ink and the reactive ink are water-soluble and mainly used for printing natural fibers such as cotton, silk, and the like. On the contrary, the dispersion ink is used mainly for printing a synthetic fiber such as polyester and the like by dispersing a dispersion dye as a pigment and a dispersing agent into water and adding an additive thereto to make the mixture into an ink.

On the other hand, natural fiber fabrics such as cotton fabrics and the like have improved sense of touch (texture), hygroscopicity, and ventilative ability compared with chemical fabrics, and thus are more preferred to synthetic fiber fabrics in the clothing market.

The natural fiber fabrics are inkjet-printed by preparing an original design through computer graphics, and outputting (printing) the original copy with an inkjet plotter onto the pre-treated fabrics by dipping the fabrics in a sizing agent (sizing material) and an alkali chemical treatment reagent, so that the fabrics may be accustomed to an inkjet ink mainly consisting of the reactive dye, and then steaming and washing the fabrics. However, the natural fiber fabrics have small expansion and shrinkage ability of fiber texture and low absorption of a dye, and thus may not secure excellent color fastness, wash fastness, and sense of touch while they maintain brilliant colors. In addition, the pre-treatment with the sizing agent or the alkali chemical treatment reagent may cause an environmental problem and the like.

### SUMMARY OF THE INVENTION

One embodiment of the present invention provides a binder composition for sublimation printing natural fibers so that a dye may be well permeated and transferred into treated natural fiber fabrics.

Another embodiment of the present invention provides a method of manufacturing a printed natural fiber fabric having improved color, sense of touch, color fastness, and wash fastness.

Another embodiment of the present invention provides a printed natural fiber fabric manufactured according to the method.

According to one embodiment of the present invention, a binder composition for sublimation printing natural fibers is provided, that includes: (A) an aqueous solvent; (B) a moisture evaporation retardant selected from urea, glycerine, and a mixture thereof; (C) a (meth)acrylic polymer; (D) a polyurethane; and (E) a blocked polyisocyanate.

The binder composition may include: about 30 to about 97.5 wt % of the aqueous solvent (A); about 1 to about 30 wt % of the moisture evaporation retardant selected from urea, glycerine, and a mixture thereof (B); about 0.1 to about 30 wt % of the (meth)acrylic polymer (C); about 0.1 to about 10 wt % of the polyurethane (D); and about 0.1 to about 10 wt % of the blocked polyisocyanate (E).

The binder composition may further include (F) a paraffin wax. The paraffin wax (F) may be included in an amount of about 0.1 to about 10 wt %.

The binder composition may further include (G) a compound selected from a linear polyester having a hydroxyl group, a mixture of hexane diol-1,6 E-caprolactone and a linear aliphatic polycarbonate polyester, a polyol, and a mixture thereof.

The compound (G) selected from the linear polyester having a hydroxyl group, the mixture of hexane diol-1,6 E-caprolactone and the linear aliphatic polycarbonate polyester, the polyol, and the mixture thereof may be included in an amount of about 0.1 to about 10 wt % based on 100 wt % of the binder composition including the (G) component.

The binder composition may further include a cross-linker selected from (H) a mixture of an alkylene diisocyanate polymer and a hydrophilic aliphatic polyisocyanate, a melamine resin, or a mixture thereof.

The cross-linker (H) selected from the mixture of the alkylene diisocyanate polymer and the hydrophilic aliphatic polyisocyanate, the melamine resin, or the mixture thereof may be included in an amount of about 0.1 to about 10 wt % based on 100 wt % of the binder composition including the (H) component.

The binder composition may further include (I) a metal formaldehyde sulfoxylate.

The metal formaldehyde sulfoxylate (I) may be included in an amount of about 0.1 to about 10 wt % based on 100 wt % of the binder composition including the (I) component.

The binder composition may further include (J) a surfactant selected from a branched secondary alcohol, a branched secondary alcohol alkoxylate, polyalkylene glycol alkyl ether, and a mixture thereof.

The surfactant (J) may be included in an amount of about 0.1 to about 10 wt % based on 100 wt % of the binder composition including the (J) component.

The binder composition may further include at least one additive selected from: (K) waterborne polyurethanes; (L) water-dispersed blocked aliphatic polyisocyanate resins; (M) a silicone softener; (N) an alkylated melamine formaldehyde; and a mixture thereof.

The at least one additive selected from the waterborne polyurethanes (K); the water-dispersed blocked aliphatic polyisocyanate resins (L); the silicone softener; the alkylated melamine formaldehyde (M); and the mixture thereof may be included in an amount of about 0.1 to about 10 wt % based on 100 wt % of the binder composition including the additive.

The binder composition may include: about 50 to about 97.5 wt % of an aqueous solvent (A); about 1 to about 10 wt % of a moisture evaporation retardant (B) selected from urea, glycerine, and a mixture thereof; about 1 to about 20 wt % of a (meth)acrylic polymer (C); about 0.1 to about 10 wt % of a polyurethane (D); about 0.1 to about 10 wt % of a blocked polyisocyanate (E); about 0.1 to about 10 wt % of a paraffin wax (F); about 0.1 to about 10 wt % of a compound (G) selected from a linear polyester having a hydroxyl group, a mixture of the hexane diol-1,6 E-caprolactone and a linear aliphatic polycarbonate polyester, a polyol, and a mixture thereof; and about 0.1 to about 10 wt % of a cross-linker (H) selected from a mixture of an alkylene diisocyanate polymer and a hydrophilic aliphatic polyisocyanate, a melamine resin, or a mixture thereof.

The binder composition may include: about 30 to about 90 wt % of an aqueous solvent (A); about 5 to about 30 wt % of a moisture evaporation retardant (B) selected from urea, glycerine, and a mixture thereof; about 0.1 to about 30 wt % of a (meth)acrylic polymer (C); about 0.1 to about 10 wt % of a polyurethane (D); about 0.1 to about 10 wt % of a blocked polyisocyanate (E); about 0.1 to about 10 wt % of a paraffin wax (F); about 0.1 to about 10 wt % of a compound (G) selected from a linear polyester having a hydroxyl group, a mixture of a hexane diol-1,6 E-caprolactone and a linear aliphatic polycarbonate polyester, a polyol, and a mixture thereof; about 0.1 to about 10 wt % of a cross-linker (H) selected from a mixture of an alkylene diisocyanate polymer and a hydrophilic aliphatic polyisocyanate, a melamine resin, or a mixture thereof; and about 0.1 to about 10 wt % of a metal formaldehyde sulfoxylate (I).

Another embodiment of the present invention provides a method of manufacturing a printed natural fiber fabric, which includes pre-treating a natural fiber fabric with the binder composition and then drying it; and printing the pre-treated natural fiber fabric.

Another embodiment of the present invention provides a printed natural fiber fabric manufactured according to the method.

### BRIEF DESCRIPTION OF THE DRAWINGS

FIG. 1 is a view showing a reference used for a crocking test in the present invention.

FIGS. 2 and 3 respectively show photographs of a printed fabric manufactured by pre-treating a cotton fabric with a binder composition according to Example 3 and printing thereon and a printed fabric manufactured by printing on a cotton fabric without the pre-treatment.

### DETAILED DESCRIPTION

This disclosure will be described more fully hereinafter in the following detailed description, in which some but not all embodiments of the present invention are described. However, the present invention may be embodied in many different forms and is not be construed as limited to the embodiments set forth herein; rather, these embodiments are provided so that the present invention will fully convey the scope of the invention to those skilled in the art. Thus, in some exemplary embodiments, well-known technologies are not specifically explained to avoid ambiguous understanding of the present invention. Unless otherwise defined, all terms used in the specification (including technical and scientific terms) may be used with meanings commonly understood by a person having ordinary knowledge in the art. Further, unless explicitly defined to the contrary, the terms defined in a generally-used dictionary are not ideally or excessively interpreted. Through the specification, unless explicitly described to the contrary, the word “comprise” will be understood to imply the inclusion of stated elements but not the exclusion of any other elements.

In addition, unless specifically described to the contrary, a singular form includes a plural form.

Natural fiber fabrics have a smaller expansion degree of fiber texture and lower absorbing ability than chemical fiber fabrics and thus may not secure improved color fastness, wash fastness, and sense of touch while maintaining vivid colors when a general printing method is applied thereto.

One embodiment of the present invention provides a binder composition for pre-treating a natural fiber fabric before printing as a subsequent process and thus provides a printed natural fabric having improved color, sense of touch, color fastness, and wash fastness.

The binder composition includes: (A) an aqueous solvent; (B) a moisture evaporation retardant selected from urea, glycerine, and a mixture thereof; (C) a (meth)acrylic polymer; (D) a polyurethane; and (E) a blocked polyisocyanate.

The binder composition may include: about 30 to about 97.5 wt % of the aqueous solvent (A); about 1 to about 30 wt % of the moisture evaporation retardant selected from urea, glycerine, and a mixture thereof (B); about 0.1 to about 30 wt % of the (meth)acrylic polymer (C); about 0.1 to about 10 wt % of the polyurethane (D); and about 0.1 to about 10 wt % of the blocked polyisocyanate (E).

The binder composition is coated on a natural fiber fabric and thus helps a dye coated thereon to be internally adsorbed and diffused before printing.

In other words, when the natural fiber fabric is pre-treated with the binder composition before the printing, a printed natural fabric having improved color, sense of touch, color fastness, and wash fastness may be obtained.

The binder composition of the present invention includes a non-toxic component rather that an organic solvent that is harmful to a human body, and thus may secure improved workability and improve flexibility of a printing process.

Hereinafter, each component of the binder composition is illustrated.

First, the aqueous solvent (A) used in the binder composition may include distilled water or pure water from which impurities are removed. When the impurities are present, they deteriorate characteristics of the binder composition such as sunlight fastness and the like and thus need to be removed. In addition, the aqueous solvent may be a mixed solvent obtained by adding alcohol or glycol ether to water. The alcohol or glycol ether may be used in an amount of about 0.1 to about 50 parts by weight based on 100 parts by weight of water. The alcohol may include C1 to C12 alcohols, and all include primary, secondary, and tertiary alcohols.

The aqueous solvent (A) may be used in an amount of about 30 to about 97.5 wt %, and specifically, its content may be determined with consideration of processability of the binder composition such as viscosity, a drying speed, and the like.

The moisture evaporation retardant (B) plays a role of retarding evaporation of moisture in the binder composition. The binder composition is coated on a fabric to be printed using a method such as screen printing and the like, and helps the binder composition appropriately contain moisture and thus improves workability. The moisture evaporation retardant (B) may be used in an amount of about 1 to about 30 wt %, and specifically, about 1 to about 20 wt %. Within the range, coating workability and drying speed of the binder composition may be improved.

The (meth)acrylic polymer (C) plays a role of a binder, and may improve stability and weather resistance of the binder composition. The (meth)acrylic polymer may include polyacrylic acid or poly(methacrylic acid). The (meth)acrylic polymer (C) may be used in an amount of about 0.1 to about 30 wt %, and specifically, about 1 to about 20 wt %. Within the range, stability and weatherability of the binder composition may be improved.

The polyurethane (D) may be used in an amount of about 0.1 to about 10 wt %, and specifically, about 0.5 to about 5 wt %. Within the range, wash fastness, and sense of touch may be improved.

The blocked polyisocyanate (E) may be, for example, synthesized from toluene 2,4-diisocyanate (TDI), isophoronediisocyanate (IPDI), dimethylol propionic acid, methyl ethyl ketoxime (MEKO), ethyl cellosolve (EC), and E-caprolactam (CL), but is not limited thereto (2011 Wiley Periodicals, Inc. J. Appl. Polym. Sci., 2011). The blocked polyisocyanate (E) may be used in an amount of about 0.1 to 10 wt %, and specifically, about 0.5 to about 5 wt %. Within the range, color fastness of a fuel[GO1], color stability, dye holding, and the like may be improved.

The binder composition may further include (F) a paraffin wax. The paraffin wax (F) plays a role of improving the sense of touch. This paraffin wax (F) may be dispersed into water. The paraffin wax (F) may be included in an amount of about 0.1 to about 10 wt % and specifically about 0.5 to about 5 wt % based on 100 wt % of the binder composition including the (F) component. Within the range, a softer sense of touch of a fabric for printing may be obtained.

The binder composition may further include (G) a compound selected from a linear polyester having a hydroxyl group, a mixture of hexane diol-1,6 E-caprolactone and a linear aliphatic polycarbonate polyester, a polyol, and a mixture thereof. The compound (G) selected from the linear polyester having a hydroxyl group, the mixture of hexane diol-1,6 E-caprolactone and the linear aliphatic polycarbonate polyester, the polyol, and the mixture thereof may be included in an amount of about 0.1 to about 10 wt %, and specifically about 0.5 to about 5 wt % based on 100 wt % of the binder composition including the (G) component. Within the range, color, sense of touch, and flexibility may be improved.

In the mixture of hexane diol-1,6 E-caprolactone and the linear aliphatic polycarbonate polyester, the linear aliphatic polycarbonate polyester and hexane diol-1,6 E-caprolactam may be used in each amount of about 90 to about 99.9 parts by weight and about 0.1 to about 10 parts by weight.

The binder composition may further include a cross-linker selected from (H) a mixture of an alkylene diisocyanate polymer and a hydrophilic aliphatic polyisocyanate, a melamine resin, or a mixture thereof. The cross-linker (H) selected from a mixture of an alkylene diisocyanate polymer and a hydrophilic aliphatic polyisocyanate, a melamine resin, or a mixture thereof helps a dye to be fixed well in a fabric for printing. The cross-linker (H) may be included in an amount of about 0.1 to about 10 wt % based on 100 wt %, and specifically about 0.5 to about 5 wt % of the binder composition including the (H) component. Within the range, dye setting and wash fastness may be improved.

In the mixture of the alkylene diisocyanate polymer and the hydrophilic aliphatic polyisocyanate, the alkylene diisocyanate polymer and the hydrophilic aliphatic polyisocyanate may be used in each amount of about 90 to about 97 parts by weight and about 3 to about 10 parts by weight.

The alkylene diisocyanate polymer may be an alkylene diisocyanate homopolymer. The alkylene may be a C4 to C8 substituted or unsubstituted alkylene. The substituted alkylene may be an alkylene substituted with a C1 to C10 alkyl group. A specific example of the alkylene diisocyanate polymer may be a hexamethylenediisocyanate homopolymer.

The binder composition may further include a metal formaldehyde sulfoxylate (I). The metal formaldehyde sulfoxylate may include a transition metal, and specific examples of the transition metal may be zinc (Zn). When the metal formaldehyde sulfoxylate (I) is further used, discharge of a dyed dark fabric may be promoted. The metal formaldehyde sufoxylate (I) may be included in an amount of about 0.1 to about 10 wt %, and specifically about 0.1 to about 5 wt % based on 100 wt % of the binder composition including the (I) component. Within the range, a dye may be easily discharged from the dyed fabric. Accordingly, various colors may be vividly printed on a dark color fabric or a dyed fabric.

The binder composition may further include (J) a surfactant selected from a branched secondary alcohol, a branched secondary alcohol alkoxylate, polyalkylene glycol alkyl ether, and a mixture thereof. An example of the branched secondary alcohol alkoxylate may be a secondary alcohol ethoxylate, and an example of the polyalkylene glycolalkylether may be polyethylene glycol trimethylnonyl ether. The surfactant (J) may be included in an amount of about 0.1 to about 10 wt % based on 100 wt % of the binder composition including the (J) component.

The binder composition may further include at least one additive selected from: (K) waterborne polyurethanes; (L) water-dispersed blocked aliphatic polyisocyanate resins; (M) a silicone softener; (N) an alkylated melamine formaldehyde, for example methylated melamine formaldehyde; and a mixture thereof.

The waterborne polyurethanes (K) may be prepared, for example, from poly(β-methyl-δ-valerolactone) glycol (PMVL) and isophoronediisocyanate.

In one embodiment of the present invention, the binder composition may include: about 30 to about 97.5 wt % of an aqueous solvent (A); about 1 to about 30 wt % of a moisture evaporation retardant selected from urea, glycerine, and a mixture thereof (B); about 0.1 to about 30 wt % of a (meth)acrylic polymer (C); about 0.1 to about 10 wt % of a polyurethane (D); about 0.1 to about 10 wt % of a blocked polyisocyanate (E); about 0.1 to 10 wt % of a paraffin wax (F); about 0.1 to about 10 wt % of a compound (G) selected from a linear polyester having a hydroxyl group, a mixture of a hexane diol-1,6 E-caprolactone and a linear aliphatic polycarbonate polyester, a polyol, and a mixture thereof; and about 0.1 to about 10 wt % of a cross-linker (H) selected from a mixture of a alkylene diisocyanate polymer and a hydrophilic aliphatic polyisocyanate, a melamine resin, or a mixture thereof.

In another embodiment of the present invention, the binder composition may include: about 50 to 97.5 wt % of an aqueous solvent (A); about 1 to 10 wt % of a moisture evaporation retardant (B) selected from urea, glycerine, and a mixture thereof; about 1 to 20 wt % of a (meth)acrylic polymer (C); about 0.1 to 10 wt % of a polyurethane (D); about 0.1 to 10 wt % of a blocked polyisocyanate (E); about 0.1 to 10 wt % of a paraffin wax (F); about 0.1 to 10 wt % of a compound (G) selected from a linear polyester having a hydroxyl group, a mixture of hexane diol-1,6 E-caprolactone and a linear aliphatic polycarbonate polyester, polyol, and a mixture thereof; and about 0.1 to about 10 wt % of a cross-linker (H) selected from a mixture of a alkylene diisocyanate polymer and a hydrophilic aliphatic polyisocyanate, a melamine resin, or a mixture thereof.

The binder composition may include: about 30 to about 90 wt % of an aqueous solvent (A); about 5 to about 30 wt % of a moisture evaporation retardant (B) selected from urea, glycerine, and a mixture thereof; about 0.1 to about 30 wt % of a (meth)acrylic polymer (C); about 0.1 to about 10 wt % of a polyurethane (D); about 0.1 to about 10 wt % of a blocked polyisocyanate (E); about 0.1 to about 10 wt % of a paraffin wax (F); about 0.1 to about 10 wt % of a compound (G) selected from a linear polyester having a hydroxyl group, a mixture of a hexane diol-1,6 E-caprolactone and a linear aliphatic polycarbonate polyester, polyol, and a mixture thereof; about 0.1 to about 10 wt % of a cross-linker (H) selected from a mixture of an alkylene diisocyanate polymer and a hydrophilic aliphatic polyisocyanate, a melamine resin, or a mixture thereof; and about 0.1 to about 10 wt % of a metal formaldehyde sufoxylate (I).

The binder composition may further include at least one additive selected from: (K) waterborne polyurethanes; (L) water-dispersed blocked aliphatic polyisocyanate resins; (M) a silicone softener; (N) alkylated melamine formaldehyde, for example methylated melamine formaldehyde; and a mixture thereof.

The alkylated melamine formaldehyde may include Melamine F (Prizm International), Astro Mel 400 (Momentive), Astro Mel NW-3A (Momentive), and the like.

The additive may be included in an amount of about 0.1 to about 10 wt %, and specifically about 0.1 to 5 wt %, based on 100 wt % of the binder composition including the additive

Within the range, dye setting and wash fastness may be improved.

The binder composition may further include a thickener (O). The thickener (O) may include Prizm ConcBuu (Prizm International). The thickener may be added to the binder composition in consideration of preservability and workability.

The binder composition may have viscosity ranging from about 10,000 to about 50,000 cps. Within the range, the coating property and workability of the binder composition may be secured.

The binder composition may be prepared by putting the aqueous solvent (A) in a mixing chamber at room temperature (about 24° C. to about 25° C.), simultaneously or sequentially adding the (B) to (F) components and selectively at least one of the (G) to (O) components thereto, and agitating the mixture at a high speed.

The binder composition may be coated on a natural fiber in a method of screen printing, roller printing, dipping, and the like, but is not limited thereto. The binder composition-coated natural fiber fabric may be naturally dried at a temperature of less than or equal to about 200° C., and specifically at a temperature ranging from about 100 to about 200° C., to perform a pre-treatment. This pre-treatment is inexpensive and is performed in a simple process, and thus is economical. In addition, the fabric has no limit regarding size, and thus the pre-treatment may be easily applied for printing a large fabric.

Then, a transfer paper printed with a sublimable dye is put on the natural fiber fabric that is pre-treated with the binder composition, and the sublimable dye is transferred thereinto with a thermal press and the like, manufacturing a printed natural fiber fabric. When the pre-treated natural fiber fabric is printed through a sublimation transfer process, a clear letter or a real image photograph may not only be transferred, but a transfer rate of the sublimable dye may be improved. The transfer has no particular limit regarding temperature and pressure, but may be performed at about 175° C. to about 215° C. with a pressure of about 40 psi to about 120 psi. In the present invention, the natural fiber fabric may include cotton, linen, leather, or fabrics mixed with a synthetic fiber.

The sublimable dye may be a pigment dye, a reactive dye, a sulfur dye, and the like. The sublimable dye is not particularly limited, and any conventionally known dyes may be used. The sublimable dye may include, for example, diarylmethane-based, triarylmethane-based, thiazole-based, merocyanine, methine-based such as pyrazolone methine and the like, indoaniline, azomethine-based such as acetphenoneazomethine, pyrazoloazomethine, imidazoleazomethine, imidazoazomethine, and pyridone azomethine, xanthene-based, oxazine-based, cyanomethylene-based such as dicyanostyrene, and tricyanostyrene, thiazine-based, azine-based, acridine-based, benzeneazo-bsed, azo-based such as pyridoneazo, thiopheneazo, isothiazoleazo, pyrroleazo, pyrazoleazo, imidazoleazo, thiadiazoleazo, triazoleazo, and the like, spiropyran-based, indolinospiropyran-based, fluorine-based, rhodaminlactam-based, naphthoquinone-based, anthraquinone-based, quinophthalone-based and the like, dyes.

Hereinafter, the present disclosure is illustrated in more detail with reference to examples. However, these examples are exemplary, and the present disclosure is not limited thereto.

Components used to prepare each binder composition according to examples and comparative examples are as follows.

TABLE 1

| | Components | Manufacturing company |
|---|---|---|
| (A) | Water | |
| (B1) | Urea | Brenntag AG Distribution Comp. |
| (B2) | Glycerin | |
| (C) | Prizm Binder BNN-3 | Prizm International |
| (D) | Ecronova Ecrothan 2012 | Michelman, Inc. |
| (E1) | Fixer N 9D | Matsui Shikiso Chemical Co., Ltd. |
| (E2) | Fix N 9DN | Matsui Shikiso Chemical Co. Ltd. |
| (F) | Michelman ML723 | Michelman, Inc. |
| (G) | OXYESTER T 1136 | Evonik Industries |
| (H) | Bayhydrol XP 2547 | Bayer AG |
| (I) | Zinc formaldehyde sulfoxide | |
| (J) | TMN6 | Dow Chemical Company |
| (L) | Bayhydrol BL 5335 | Bayer AG |
| (M) | Prizm Silicone Softener C-60 | Prizm International |
| (N) | Melamine F | Prizm International |

The components and their contents in the following Table 2 were used to prepare the binder compositions for sublimation printing of a natural fiber according to Examples 1 to 17 and Comparative Examples 1 to 4.

TABLE 2
(unit: wt %)

| | Test No. | (A) | (B1) | (B2) | (C) | (D) | (E1) | (E2) | (F) | (G) | (H) | (I) | (J) | (M) | (N) |
|---|---|---|---|---|---|---|---|---|---|---|---|---|---|---|---|
| Ex. 1 | 6R | 71 | 1 | 0 | 4 | 4 | 7 | 0 | 3 | 0 | 8 | 0 | 1 | 1 | 0 |
| Ex. 2 | 6O | 65.5 | 1 | 0 | 5 | 5 | 10 | 0 | 5 | 0 | 0 | 0 | 1 | 0 | 7.5 |
| Ex. 3 | 9D | 74 | 1 | 0 | 4 | 4 | 0 | 5.5 | 3 | 0 | 6.5 | 0 | 1 | 1 | 0 |
| Ex. 4 | 8Y | 82.5 | 1 | 0 | 4 | 1 | 0 | 1.5 | 0 | 1.5 | 6.5 | 0 | 1 | 1 | 0 |
| Ex. 5 | 6AA | 81 | 2 | 0 | 4 | 1 | 0 | 2 | 0 | 1.5 | 3.5 | 0 | 1 | 1 | 3 |
| Ex. 6 | 2Y | 80.5 | 3 | 0 | 4 | 1 | 0 | 1.5 | 0 | 2.5 | 5.5 | 0 | 1 | 1 | 0 |
| Ex. 7 | 3Y | 81.5 | 3 | 0 | 4 | 1 | 0 | 1.5 | 0 | 2.5 | 4.5 | 0 | 1 | 1 | 0 |
| Ex. 8 | 4Y | 82.5 | 3 | 0 | 4 | 1 | 0 | 1.5 | 0 | 2.5 | 3.5 | 0 | 1 | 1 | 0 |
| Ex. 9 | 2W | 83 | 1 | 0 | 4 | 1 | 0 | 1.5 | 0 | 1 | 6.5 | 0 | 1 | 1 | 0 |
| Ex. 10 | 7W | 81 | 1 | 0 | 4 | 1 | 0 | 1.5 | 0 | 3 | 6.5 | 0 | 1 | 1 | 0 |
| Ex. 11 | 4AA | 65 | 17 | 0 | 5 | 1 | 0 | 2 | 3 | 1.5 | 4.5 | 0 | 1 | 0 | 0 |
| Ex. 12 | 5AA | 66 | 17 | 0 | 5 | 1 | 0 | 2 | 3 | 1.5 | 3.5 | 0 | 1 | 0 | 0 |
| Ex. 13 | 5BB | 71 | 12 | 0 | 5 | 1 | 0 | 2 | 3 | 1.5 | 3.5 | 0 | 1 | 0 | 0 |
| Ex. 14 | 7BB | 69 | 14 | 0 | 5 | 1 | 0 | 2 | 3 | 1.5 | 3.5 | 0 | 1 | 0 | 0 |
| Ex. 15 | 8BB | 68 | 15 | 0 | 5 | 1 | 0 | 2 | 3 | 1.5 | 3.5 | 0 | 1 | 0 | 0 |
| Ex. 16 | 4AA-1 | 60 | 17 | 0 | 5 | 1 | 0 | 2 | 3 | 1.5 | 4.5 | 5 | 1 | 0 | 0 |
| Ex. 17 | 5AA-1 | 61 | 17 | 0 | 5 | 1 | 0 | 2 | 3 | 1.5 | 3.5 | 5 | 1 | 0 | 0 |
| Comp. | U | 82 | 1 | 0 | 0 | 0 | 0 | 5.5 | 0 | 3 | 6.5 | 0 | 1 | 1 | 0 |
| Ex. 1 | | | | | | | | | | | | | | | |
| Comp. | 6Z | 83 | 3 | 0 | 4 | 1 | 0 | 1.5 | 0 | 1 | 4.5 | 0 | 1 | 0 | 0 |
| Ex. 2 | | | | | | | | | | | | | | | |

The binder compositions according to Examples 1 to 17 to Comparative Examples 1 and 2 were respectively coated on each of 100% cotton fabrics with a 180 mesh aluminum silk screen printer. Next, the fabrics coated with the binder composition were dried at 160 to 172° C., and a design was printed thereon by using a digital sublimation machine. Then, the design-printed fabric was thermally compressed at 204° C. with a pressure of 80 Psi for 20 seconds, manufacturing a printed cotton fabric.

Color, sense of touch, and color fastness of the printed cotton fabric were evaluated, and the results are provided in the following Table 3.

### Color Evaluation

The color was evaluated based on the following references. The color evaluation was performed by printing the sublimable dye with the same design on a polyester fabric.

1: If color is closer to cotton;

2: color 10% better than printed cotton;

3: Color 20% better than printed cotton;

4: Color 30% better than printed cotton;

5: Color 40% better than printed cotton;

6: Color 50% better than printed cotton;

7: Color 60% better than printed cotton;

8: Color 70% better than printed cotton;

9: Color 80% better than printed cotton; and

10: Color 90% better than printed cotton.

### Sense of Touch Evaluation

The sense of touch evaluation was performed as follows.

1: Stiff as plastic;

2: Stiff as cardboard;

3: Stiff as 80 lb paper;

4: Stiff as 60 lb paper;

5: Stiff as 40 lb paper;

6: Stiff as a 300 mil plastic bag;

7: Stiff as a 180 to 200 mil plastic bag;

8: Stiff as a 90 to 100 mil plastic bag;

9: Stiff as heavy cotton jersey fabric;

10: Same sense of touch as fabric; and

Greater than 10: Sense of touch is better than the fabric itself.

### Color Fastness (Crocking) Evaluation

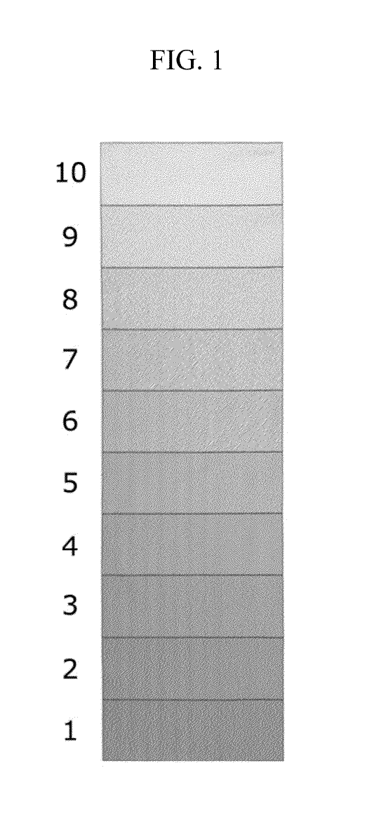

The printed cotton fabrics according to Examples 1 to 17 and Comparative Examples 1 and 2 after the pre-treatment were respectively rubbed 10 times on a wet white crock test cloth by using a crockmeter. Then, the color fastness of a dye transferred onto the test fabric was evaluated according to a reference provided in FIG. 1.

The results are provided in the following Table 3.

TABLE 3

| | | Sense of | Color fastness |
|---|---|---|---|
| | Color | touch | (crocking) |
| Example 1 | 10 | 10 | 10 |
| Example 2 | 9.5 | 7 | 8 |
| Example 3 | 10.5 | 9 | 9.3 |
| Example 4 | 9 | 9 | 9 |
| Example 5 | 11 | 10 | 9.8 |
| Example 6 | 10 | 10 | 9 |
| Example 7 | 11 | 10 | 9.5 |
| Example 8 | 11 | 10 | 9.5 |
| Example 9 | 10.5 | 9.5 | 9.5 |
| Example 10 | 10.5 | 9.5 | 9 |
| Example 11 | 9 | 9 | 9 |
| Example 12 | 9 | 9 | 8.5 |
| Example 13 | 8.8 | 9 | 9 |
| Example 14 | 9 | 9 | 9 |
| Example 15 | 9 | 9 | 9 |
| Example 16 | 9 | 9 | 9 |
| Example 17 | 9 | 9 | 8.5 |
| Comparative Example 1 | 8.5 | 8.7 | 8.5 |
| Comparative Example 2 | 10 | 7 | 9 |

As shown in Table 3, each printed fabric manufactured by respectively using the cotton fabrics that were pre-treated with the binder compositions according to Examples 1 to 17 showed improved color, sense of touch, and color fastness compared with each printed fabric manufactured by respectively using the cotton fabrics pre-treated with the binder compositions according to Comparative Examples 1 and 2.

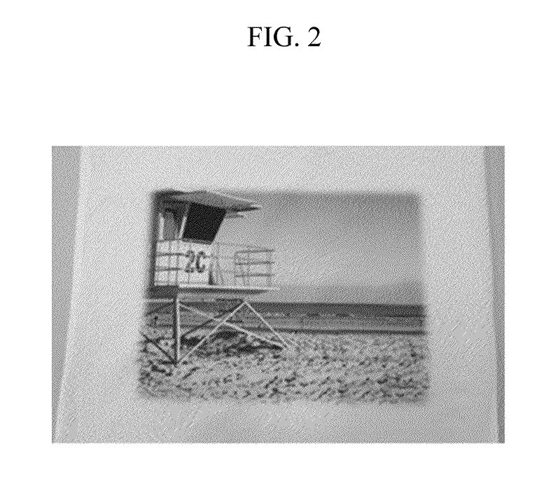

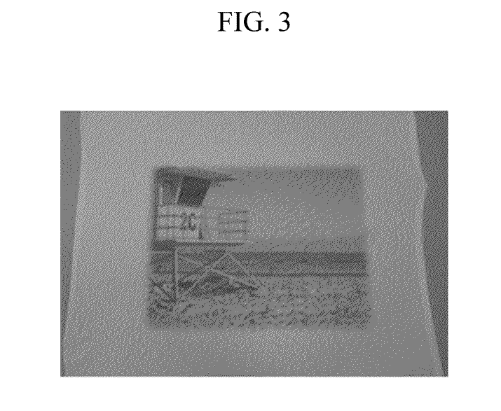

FIGS. 2 and 3 show a printed cotton fabric after pre-treatment with the binder composition according to Example 3 and a printed cotton fabric without pre-treatment (a control group). The printed cotton fabric after pre-treatment with the binder composition according to Example 3 (FIG. 2) looked clear compared with the printed cotton fabric without pre-treatment (FIG. 3).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A binder composition for sublimation printing natural fibers, comprising:
(A) an aqueous solvent;
(B) a moisture evaporation retardant selected from urea, glycerine, and a mixture thereof;
(C) a (meth)acrylic polymer;
(D) a polyurethane; and
(E) a blocked polyisocyanate.

2. The binder composition of claim 1, wherein the binder composition comprises: about 30 to about 97.5 wt % of the aqueous solvent (A); about 1 to about 30 wt % of the moisture evaporation retardant selected from urea, glycerine, and a mixture thereof (B); about 0.1 to about 30 wt % of the (meth)acrylic polymer (C); about 0.1 to about 10 wt % of the polyurethane (D); and about 0.1 to about 10 wt % of the blocked polyisocyanate (E).

3. The binder composition of claim 1, wherein the binder composition further comprises (F) a paraffin wax.

4. The binder composition of claim 3, wherein the paraffin wax (F) is included in an amount of about 0.1 to about 10 wt % based on 100 wt % of the binder composition including the (F) component.

5. The binder composition of claim 1, wherein the binder composition further comprises (G) a compound selected from a linear polyester having a hydroxyl group, a mixture of hexane diol-1,6 E-caprolactone and a linear aliphatic polycarbonate polyester, a polyol, and a mixture thereof.

6. The binder composition of claim 5, wherein the compound (G) selected from the linear polyester having a hydroxyl group, the mixture of hexane diol-1,6 E-caprolactone and the linear aliphatic polycarbonate polyester, the polyol, and the mixture thereof is included in an amount of about 0.1 to about 10 wt % based on 100 wt % of the binder composition including the (G) component.

7. The binder composition of claim 1, wherein the binder composition further comprises (H) a mixture of an alkylene diisocyanate polymer and a hydrophilic aliphatic polyisocyanate, a melamine resin, or a mixture thereof.

8. The binder composition of claim 7, wherein the cross-linker (H) selected from the mixture of the alkylene diisocyanate polymer and the hydrophilic aliphatic polyisocyanate, the melamine resin, or the mixture thereof is included in an amount of about 0.1 to about 10 wt % based on 100 wt % of the binder composition including the (H) component.

9. The binder composition of claim 1, wherein the binder composition further comprises a metal formaldehyde sulfoxylate (I).

10. The binder composition of claim 9, wherein the metal formaldehyde sufoxylate (I) is included in an amount of about 0.1 to about 10 wt % based on 100 wt % of the binder composition including the (I) component.

11. The binder composition of claim 1, wherein the binder composition further comprises (J) a surfactant selected from a branched secondary alcohol, a branched secondary alcohol alkoxylate, a polyalkylene glycol alkyl ether, and a mixture thereof.

12. The binder composition of claim 11, wherein the surfactant (J) is included in an amount of about 0.1 to about 10 wt % based on 100 wt % of the binder composition including the (J) component.

13. The binder composition of claim 1, wherein the binder composition further comprises at least one additive selected from: (K) waterborne polyurethanes; (L) water-dispersed blocked aliphatic polyisocyanate resins; (M) a silicone softener; (N) an alkylated melamine formaldehyde; and a mixture thereof.

14. The binder composition of claim 13, wherein the at least one additive selected from: the waterborne polyurethanes (K); the water-dispersed blocked aliphatic polyisocyanate resins (L); the silicone softener; the alkylated melamine formaldehyde (M); and the mixture thereof is included in an amount of about 0.1 to about 10 wt % based on 100 wt % of the binder composition including the additive.

15. A binder composition for sublimation printing natural fibers, comprising:
about 50 to about 97.5 wt % of an aqueous solvent (A);
about 1 to about 10 wt % of a moisture evaporation retardant (B) selected from urea, glycerine, and a mixture thereof;
about 1 to about 20 wt % of a (meth)acrylic polymer (C);
about 0.1 to about 10 wt % of the polyurethane (D);
about 0.1 to about 10 wt % of blocked polyisocyanate (E);
about 0.1 to about 10 wt % of a paraffin wax (F);
about 0.1 to about 10 wt % of a compound (G) selected from a linear polyester having a hydroxyl group, a mixture of the hexane diol-1,6 E-caprolactone and a linear aliphatic polycarbonate polyester, a polyol, and a mixture thereof; and
about 0.1 to about 10 wt % of a cross-linker (H) selected from a mixture of an alkylene diisocyanate polymer and a hydrophilic aliphatic polyisocyanate, a melamine resin, or a mixture thereof.

16. A binder composition for sublimation printing natural fibers, comprising:
about 30 to about 90 wt % of an aqueous solvent (A);
about 5 to about 30 wt % of a moisture evaporation retardant (B) selected from urea, glycerine, and a mixture thereof;
about 0.1 to about 30 wt % of a (meth)acrylic polymer (C);
about 0.1 to about 10 wt % of a polyurethane (D);
about 0.1 to about 10 wt % of a blocked polyisocyanate (E);
about 0.1 to about 10 wt % of a paraffin wax (F);
about 0.1 to about 10 wt % of a compound (G) selected from a linear polyester having a hydroxyl group, a mixture of a hexane diol-1,6 E-caprolactone and a linear aliphatic polycarbonate polyester, a polyol, and a mixture thereof;
about 0.1 to about 10 wt % of a cross-linker (H) selected from a mixture of an alkylene diisocyanate polymer and a hydrophilic aliphatic polyisocyanate, a melamine resin, or a mixture thereof; and
about 0.1 to about 10 wt % of a metal formaldehyde sulfoxylate (I).

17. A method of manufacturing printed natural fiber fabric, comprising:
pre-treating a natural fiber fabric by coating the natural fiber fabric with the binder composition of claim 1 and drying it; and
printing the pre-treated natural fiber fabric.

18. A method of manufacturing printed natural fiber fabric, comprising:
pre-treating a natural fiber fabric by coating the natural fiber fabric with the binder composition of claim 15 and drying it; and
printing the pre-treated natural fiber fabric.

19. A method of manufacturing printed natural fiber fabric, comprising:
pre-treating a natural fiber fabric by coating the natural fiber fabric with the binder composition of claim 16 and drying it; and
printing the pre-treated natural fiber fabric.

20. A printed natural fiber fabric according to claim 17.

21. A printed natural fiber fabric according to claim 18.

22. A printed natural fiber fabric according to claim 19.
